(19) United States
(12) Patent Application Publication
(10) Pub. No.: US 2015/0170203 A1
(43) Pub. Date: Jun. 18, 2015

(54) PRESENTING SEARCH RESULTS

(71) Applicant: David Kogan, Natick, MA (US)

(72) Inventor: David Kogan, Natick, MA (US)

(21) Appl. No.: 13/115,053

(22) Filed: May 24, 2011

(51) Int. Cl. G06Q 30/02

(52) U.S. Cl. CPC G06Q 30/0256; G06F 17/30554; G06F 17/30864

(57) ABSTRACT

This specification describes technologies relating to presenting search results. In general, one aspect of the subject matter described in this specification can be embodied in methods that include the actions of receiving a search query; determining a user interface area available for presenting search results if one or more content items are included; identifying search results responsive to the search query for the available user interface area; sending the identified search results for display; determining whether or not content items are to be included; and if content items are not included: identifying additional search results for a portion of the user interface area for which search results are not presented, and sending the additional search results.

### BACKGROUND

This specification relates to presenting search results.

Internet search engines aim to identify resources (e.g., web pages, images, text documents, multimedia context) that are relevant to a user's needs and to present information about the resources in a manner that is most useful to the user. Internet search engines return a set of search results in response to a user submitted query.

Search results are typically presented in an ordered listing, e.g., for text results, or in an array, e.g., for image search results. Other content can be presented along with the search results including, for example, one or more advertisements.

### SUMMARY

This specification describes technologies relating to presenting search results.

In general, one aspect of the subject matter described in this specification can be embodied in methods that include the actions of receiving a search query; determining a user interface area available for presenting search results if one or more content items are included; identifying search results responsive to the search query for the available user interface area; sending the identified search results for display; determining whether or not content items are to be included; and if content items are not included: identifying additional search results for a portion of the user interface area for which search results are not presented, and sending the additional search results.

Other embodiments of this aspect include corresponding systems, apparatus, and computer program products. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. If content items are included, sending the content items for display. The search query is an image search query and the available user interface area is the area for which whole image search results can be presented. The search query is a video search query and the available user interface area is the area for which whole video search results can be presented. The content items are advertisements. Determining the user interface area available if one or more content items are included includes: receiving the display information, and determining a size of the one or more content items. The identified search results and the additional search results are ranked, and wherein the additional search results are ranked lower than the identified search results. The number of the included content items is less than the number of content items that can be displayed in the display area, and wherein additional search results are identified for display along with the content items and the identified search results.

In general, one aspect of the subject matter described in this specification can be embodied in methods that include the actions of receiving a search query; sending the search query and user interface dimensions for a user interface area to present search results and content items; receiving the search results and display area dimensions of a display area within the user interface area for the content items; displaying the search results in the user interface area, but not in the display area; receiving the content items if the content items are available; and if the content items are not available, receiving additional search results and displaying the additional search results in the user interface area.

Other embodiments of this aspect include corresponding systems, apparatus, and computer program products. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can optionally include one or more of the following features. If the content items are received, displaying the content items in the display area.

Particular embodiments of the subject matter described in this specification can be implemented so as to realize one or more of the following advantages. Latency can be reduced by laying out image search results without waiting for a determination of whether or not to include ad content. Search results can be changed for various reasons, including adding search results for latency improvement, updating search results to improved query-specific results, and removing search results if behavior indicates negative feedback.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a diagram of an example system.

FIG. 2A is a flow chart of an example process for presenting search results.

FIG. 2B is a flow chart of another example process for presenting search results.

FIG. 3 is a flow diagram of an example process for presenting search results.

FIG. 4A is an example search result page for presenting search results.

FIG. 4B is an example search result page for presenting search results with advertisements.

FIG. 4C is an example search result page for presenting search results with additional search results.

FIG. 5 is an example architecture of a system.

Like reference symbols in the various drawings indicate like elements.

### DETAILED DESCRIPTION

When a request for search results is received (e.g., in response to a user input of one or more query terms), requests can be sent for both search results and advertisements (ads). In particular, given the available user interface area (e.g., within a web browser) for presenting search results if ads are included, a request is made for search results to fill the available user interface area. Thus, if one or more ads are included, the presented search results will fill the available user interface area when presented with the one or more ads (e.g., reducing extra white space on the page).

In particular, the search results can be returned while waiting to determine whether or not one or more ads are to be presented with the search results. In some implementations, an autocomplete dropdown is presented to a user as they are entering a search query. The autocomplete dropdown includes suggested queries based on what the user has entered. Search results based on what the user has typed are presented below the autocomplete dropdown. The search results can be presented according to a layout that presents the results within the available user interface area minus a region reserved for potential ads. The layout can include a search results area and a display area. The display area can be reserved for one or more content items. The content items are displayed objects other than the presented search results. The content items can be text, images, video, or a combination. In some implementations, the content items are sponsored content (e.g., advertisements). The search results area can present the received search results.

If one or more ads are to be included with the search results, the ads are sent with the search results for presentation. In particular, the ads can be presented in the same space used for the autocomplete dropdown. If an ad is not to be included with the search results, the presented search results can be shifted up with removal of the autocomplete dropdown (e.g., corresponding to the region reserved for potential ads). A request is made for additional search results while sending received search results for display. The additional search results are sent for presentation when received.

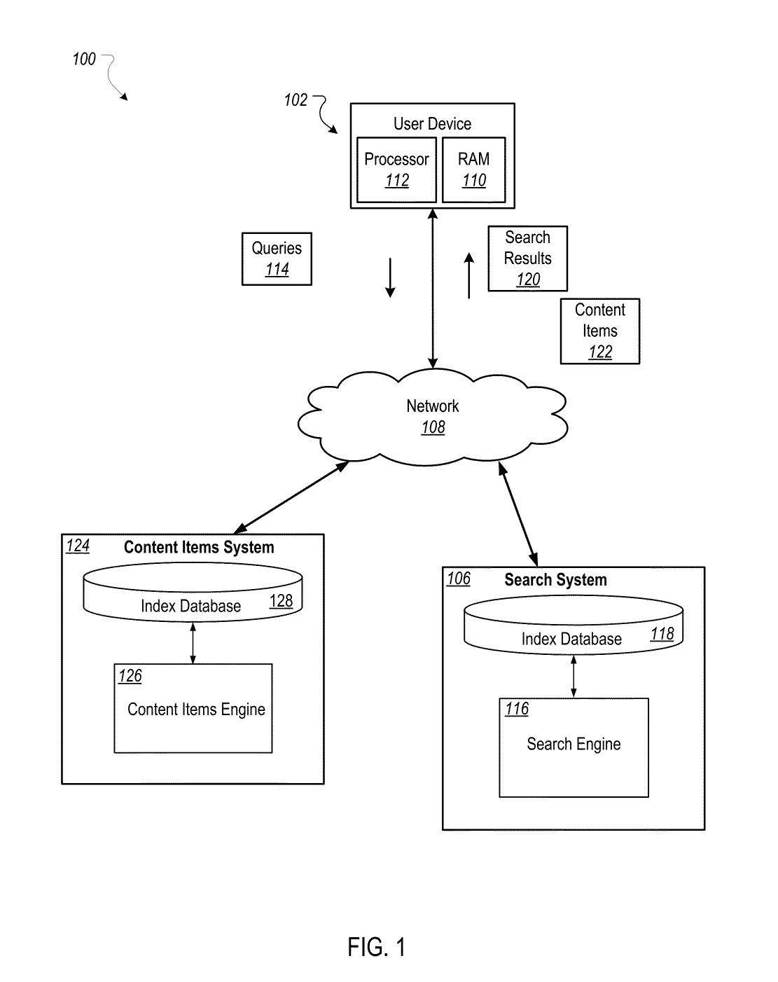

FIG. 1 is a diagram of an example system 100. The system 100 provides search results relevant to submitted queries as can be implemented in an internet, an intranet, or another client and server environment. The serving system 100 is an example of an information retrieval system in which the systems, components, and techniques described below can be implemented.

A user device 102 is a computer coupled to the search system 106 through a network 108, for example, a local area network (LAN) or wide area network (WAN), e.g., the Internet. In some implementations, the search system 106 and the user device 102 can be one machine. For example, a user can install a desktop search application on the user device 102. The user device 102 will generally include a random access memory (RAM) 110 and a processor 108.

A query 114 can be submitted to a search engine 116 within a search system 106 from the user device 102. When the query 114 is submitted, the query 114 is transmitted through a network to the search system 106. The search system 106 can be implemented as, for example, computer programs running on one or more computers in one or more locations that are coupled to each other through the network 108. The search system 106 includes an index database 118 and the search engine 116. The search system 106 responds to the query 114 by generating search results 120, which are transmitted through the network to the user device 102 (e.g., as a search results web page to be displayed in a web browser running on the user device 102). When the query 114 is received by the search engine 116, the search engine 116 identifies resources that match, or are responsive to, the query 114.

When the query 114 is submitted to the search system 106, a request for content items 122 can be sent to a content item system 124 by the user device 102. In some implementations, the query 114 can include the request. When the request is submitted, the request is transmitted through the network 108 to the content item system 124. The content item system 124 can be implemented as, for example, computer programs running on one or more computers in one or more locations that are coupled to each other through a network. The content item system 124 determines whether to provide content items in response to a request as well as the particular content items to provide. The content item system 124 responds to the request by providing identified content items 122, which are transmitted through the network in the user device 102 (e.g., as a search results web page to be displayed in a web browser running on the user device 102). If the content items 122 are not provided by the content item system 124, the search system 106 can provide additional search results 120.

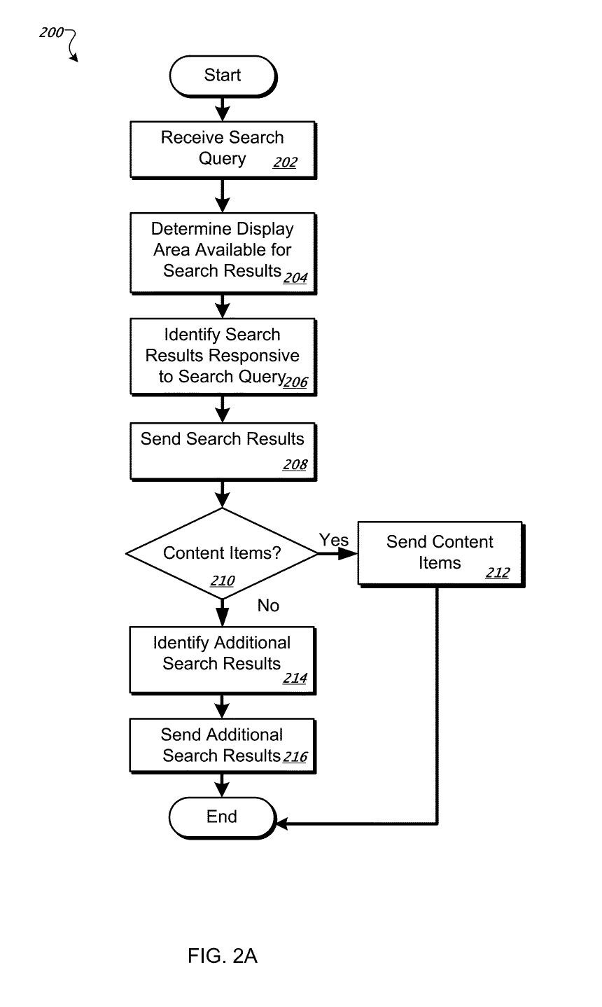

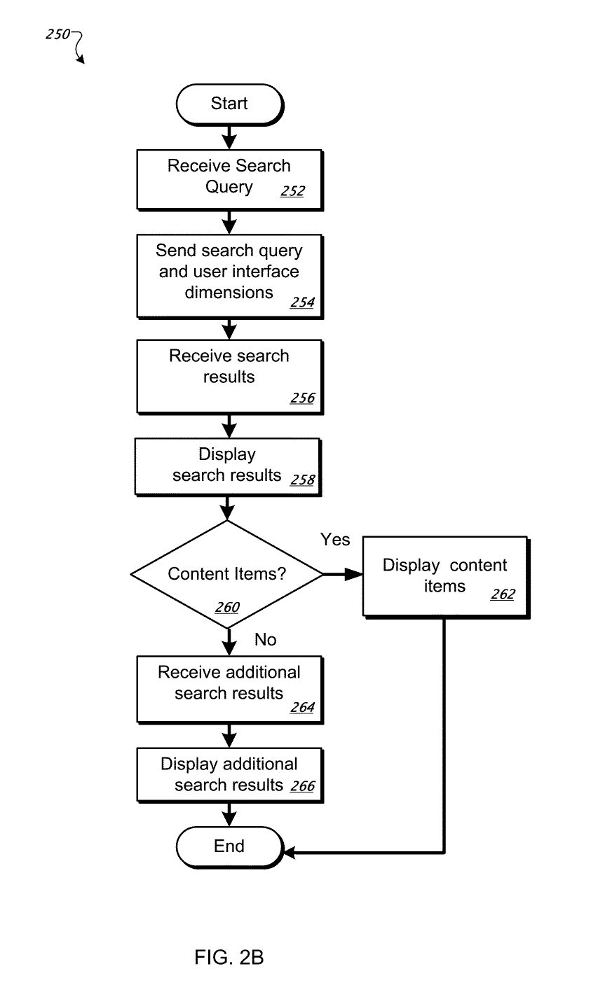

FIG. 2A is a flow chart of an example process 200 for presenting search results. For convenience, the process 200 will be described with respect to a system, including one or more computing devices, that performs the process 200.

The system receives a search query (202). Search queries can include a variety of queries. For example, the queries can include web search queries, image search queries, video search queries, and shopping queries. The search query can include one or more terms received from a user. For example, the search query can be “Eiffel.” During entry of the search query to the system, suggestions can be provided to the user in a drop down menu so that the user can select from different options based on other users' search activities. The searches can be algorithmically determined based on a number of objective factors (e.g., popularity of search terms) without human intervention. For example, the user can enter “eiffel,” and the system can suggest “Eiffel Tower,” “Eiffel Tower at night,” Eiffel Tower Paris,” and/or “Eiffel Tower pictures.” The system can provide suggestions based on a word-completion algorithm. Alternatively, the system can provide suggestions based on historical data from prior search terms.

The search query can be an image search query. An image search query can be a textual search query seeking particular image resources responsive to the image search query. For example, a user can send the system an image search query that describes a particular image or type of image. The system can send the received image search query to an image search engine that identifies search results responsive to the image search query. The image search query can provide information about one or more images associated with a topic, a website, a webpage, an offline database, an online database, a transaction, a document, a photograph, a drawing, or other content. The image query can include one or more query terms identifying requested image content. The query terms can identify one or more search strings (e.g., red rose bouquet, apple, bakery logo), image features (e.g., color, texture, dimension), file type (e.g., bitmap, jpeg, tiff) or any combination of the above. Alternatively, in some other implementations, the query itself is an image. In some implementations, the search query is a video search query (e.g., a search query seeking particular video resources responsive to the video search query).

The system determines a user interface area available for presenting search results (204). In some implementations, the search query includes browser size information for a browser to assist the system in determining the user interface area available for search results. Alternatively, in some other implementations, the browser size information is submitted contemporaneously (e.g., by the browser) with the search query. For example, the data for the pixel width and height of the browser can be provided using a script (e.g., JavaScript code) that is automatically provided with the search query. Additional layout information can be provided, for example, the layout of navigation elements of the browser which affects the available user interface area for presenting search results. Additionally, other page elements can be identified by the system (e.g., a header, logo, search field, etc.). Based on this information, the portion of the user interface area available for presenting search results can be determined.

The system can determine the number of the search results that are needed so that whole search results are displayed in the available user interface area. For example, if the search query is an image search query, the available user interface area has a certain number of whole image search results that can completely fit inside (e.g., thumbnail representations of image resources responsive to the query). Thus, no partial images are displayed (e.g., such that a user would need to scroll down to see the entire image search result). In another example, if search query is a video search query, the system can determine the available user interface area is the area for which whole video search results can be presented. In some implementations, the image search results size can be adjusted before being presented.

The system identifies search results responsive to the search query (206). The search results can be text, images, video, or a combination. The search results can identify corresponding image resources relevant to the received image query. For example, a search system can include a ranking engine that ranks image search results responsive to a received query according to one or more criteria. The system sends the identified search results for display (208). For example, the system can receive four images to be displayed. The system can determine that the four images should be displayed in a row or that the four images should be displayed two across and two down, depending on the dimensions of the user interface area.

The system determines whether there are content items (210). The content items can be text, images, video, or a combination. In some implementations, the content items are advertisements. The content items can be identified in response to the search query. For example, the system can send a request for content items (e.g., to the content item system 124 in FIG. 1), where the request includes information associated with the search query. For example, the request can include the search terms as keywords, which can be used to identify content items associated with the keywords. In some implementations, the number of content items retrieved from the content items store is zero based on the information from the queries. Alternatively, the content items can be random content items in response to the system request. In some implementations, the content items are determined based on an outside factor, such as a price an advertiser pays associated with a display of the content item.

If there are content items, the system sends the content items for display (212). If there are no content items, the system identifies additional search results (214).

The web browser can determine a layout for displaying the search results. For example, the browser can have a display area in the user interface area, or an area to display content items. The space inside the user interface area can be calculated in order to determine the number of search results that can be displayed along with content items. For example, sixteen image results can be displayed four across and four down or eight across and two down on the web browser. The search results can be text, images, video, or a combination. The web browser can determine a way to display the search results.

The system identifies additional search results (214). The system can send an additional request for the additional search results. In particular, if no content items are returned for display, additional search results can be identified such that the unused area of the browser user interface can be filled. The system can determine, based on the size of the unused display area and the rest of the unused user interface area, how many additional search results can be displayed. In some implementations, the request may not be exactly the size of the available user interface area. Instead, the request can be for a bigger set so that if there is scrolling capability, one or more search results can be available for display.

The system sends the additional search results (216). The system can send the additional search results for display below the identified search results. Alternatively, the system can send the additional search results for display in the display area. In some implementations, the system specifies the layout for the additional search results (e.g., positioned within the user interface area below the previously sent search results). Alternatively, the browser can determine the layout upon receipt of the additional search results.

In some implementations, the size of the content items is too large to display in the display area. For example, an advertisement can be a banner ad that is 728×90 pixels (e.g., a “leaderboard” size based on, for example, standard interactive marketing unit (IMU) ad formats), while the display area is only large enough for a 460×60 pixel image (e.g., a “full banner”). The content items can be rejected because of the size discrepancy, leading to a request for additional search results for display in place of the content item. Alternatively, parameters can be sent so that selected ads have to conform to a specified size (and thus will fit in the designated area). In some implementations, the display area can be increased so that the content items can be displayed, and the identified search results can be reduced based on the space left to display search results.

If the number of the retrieved content items is more than zero, the retrieved content items can be sent for display. For example, the number of retrieved content items can be three content items. The content items can be placed in a display area based on the information received regarding the user interface area size.

If the number of the retrieved content items is zero, additional search results can be requested. In some implementations, the additional search results are ranked so that the most relevant additional search result follow a ranking order subsequent to the ranking of the previously identified search results displayed in the browser.

FIG. 2B is a flow chart of an example process 250 for presenting search results. For convenience, the process 200 will be described with respect to a system, including one or more computing devices, that performs the process 250.

The system receives a search query (252). Search queries can include a variety of queries. For example, the queries can include web search queries, image search queries, video search queries, and shopping queries. The search query can include one or more terms received from a user. For example, the search query can be “Eiffel.” For example, the user can input the query “Eiffel” into a field of a search interface. The search query can be received, for example, within a search interface displayed on a client browser. For example, a user can use one or more input devices to provide the search query (e.g., keyboard or touchscreen).

The system sends search query and user interface dimensions for a user interface area to present search results and content items (254). For example, the dimensions of an open web browser can be sent using a particular script in order to provide the area available for display of content including search results and content items.

The system receives the search results (256). The received search results can include a layout for presenting the search results according to the available user interface dimensions including specifying a display area reserved for one or more content items. In some implementations, the display area dimensions include data for positioning the search results within the user interface area. The positioning data can be relative positioning data, such as below a search toolbar. The positioning data can be fixed within the user interface system, such as including x and y coordinates. The display area can be above a search results area. In some implementations, the display area is to the side of the search results area, below the search area, or any combination of above, to the side, and below.

The system displays the search results (258). In some implementations, the search results are displayed in the search results area, but not in the display area. For example, the system can receive four images to be displayed. The system can determine that the four images should be displayed in a row or that the four images should be displayed two across and two down, depending on the dimensions of the user interface area.

The system determines whether content items are received (260). If content items are received, the system displays the content items in the display area (262). If content items are not received, the system receives additional search results (264) and displays the additional search results (266). In some implementations, the system can move the earlier received search results (256) into the display area and display the additional search results below the identified search results, e.g., shift results up.

Alternatively, the system can display the additional search results within the display area. Depending on the dimensions of the display area, the image search results can be resized so that the full set is displayed. During entry of the search query to the system, query autocomplete suggestions can be provided to the user in a drop down menu so that the user can select from different options based on other users' search activities. The searches can be algorithmically determined based on a number of objective factors (e.g., popularity of search terms) without human intervention. In particular, the received search results can be displayed below the drop down menu. When the search is executed, such that the drop down menu is no longer displayed, the displayed results can be shifted up in place of where the drop down menu was. Alternatively, received content items can be displayed in place of the drop down menu. Thus, the display area can correspond to the area or to the height of the drop down menu.

In some implementations, the number of the retrieved content items is less than the number of content items that can be displayed in the display area, but still greater than zero. For example, each content item can occupy the same space as two search results. If there are only two content items retrieved with space in the display area for three search results, the content items can be displayed and two additional search results can be requested. The retrieved content items can be sent for display in a web browser. Additional search results can be requested for display along with the retrieved content items and the identified search results.

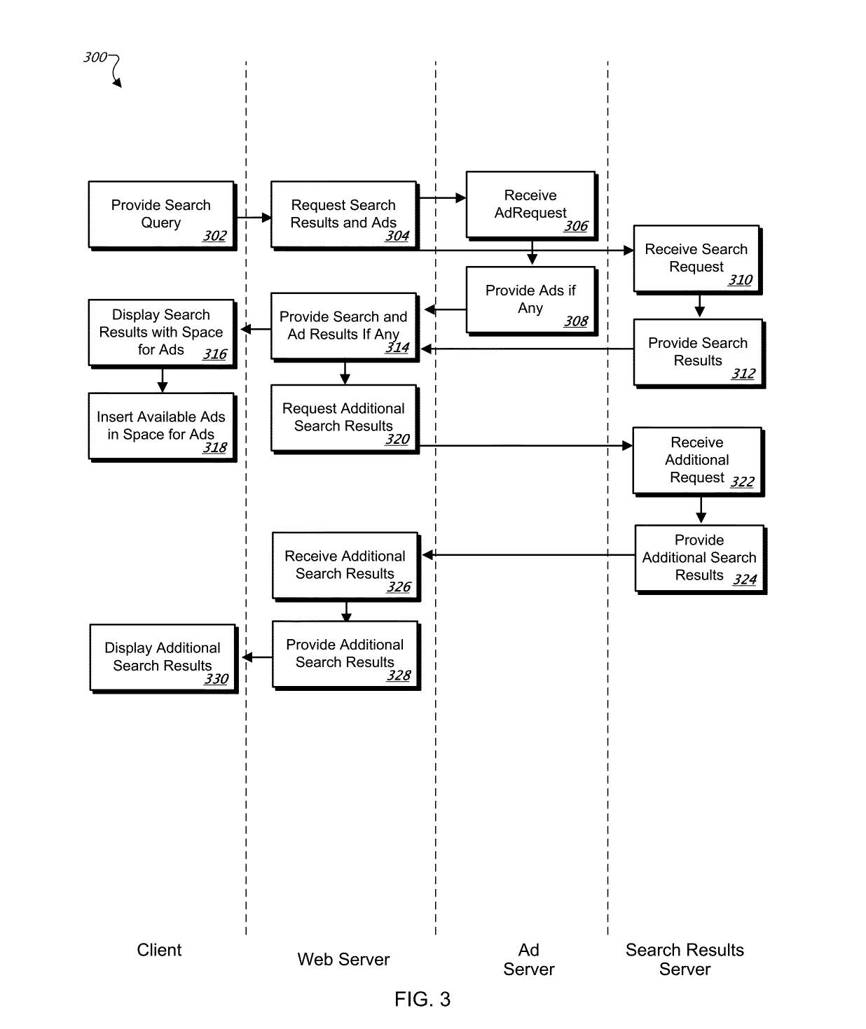

FIG. 3 is a flow diagram of another example process 300 for presenting search results. It should be understood that any of the actions within the example process 300 can be taken in any order. The example process 300 depicts data flow among a client, a web server, an ad server, and a search results server.

The client provides a search query to the web server (302). The web server requests search results and advertisements (304) from the ad server and the search results server. The ad server receives the ad request from the web server (306) and provides ad results to the web server if there are ad results (308). The search results server receives the search request from the web server (310) and provides search results to the web server (314).

The web server provides the search results and the ad results (if available) to the client (314). The client displays the search results, reserving a space for the ad results (316). If the ad results are available, the client displays the ad results in the reserved space (318).

If the web server determines that there are no ad results, the web server requests additional search results from the search results server (320). In some implementations, the web server also requests additional search results when there are ad results. For example, this allows for the presentation of additional search results in response to user input, e.g., scrolling the user interface.

The search results server receives the request for additional search results (322). The search results server provides the additional search results to the web server (324). The web server receives the additional search results from the search results server (326). The web server provides the additional search results to the client (328). The client displays the additional search results (330).

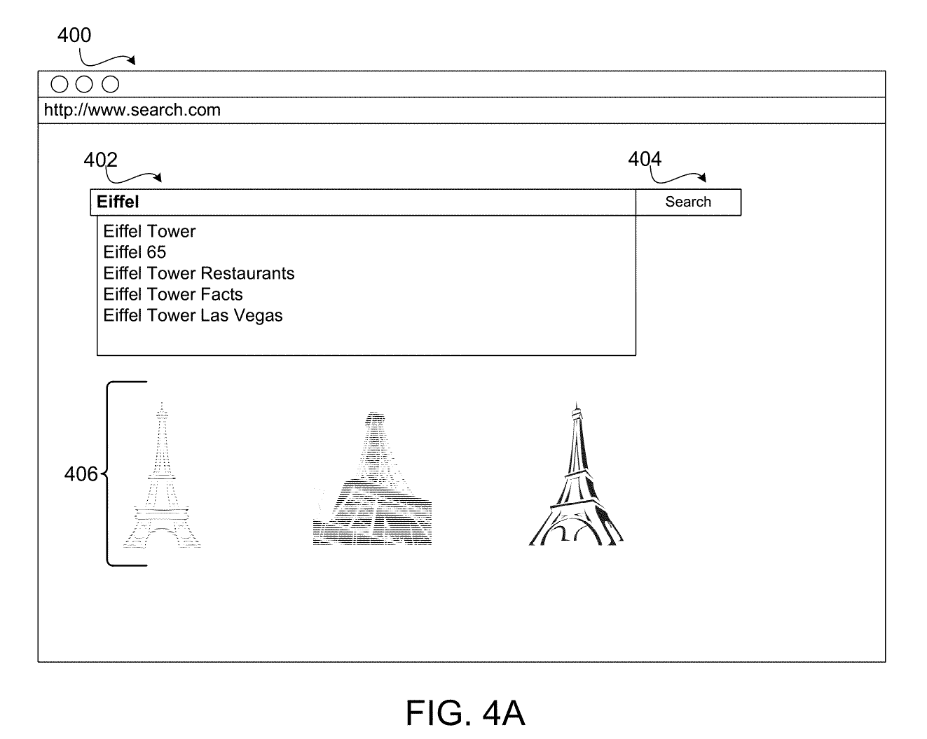

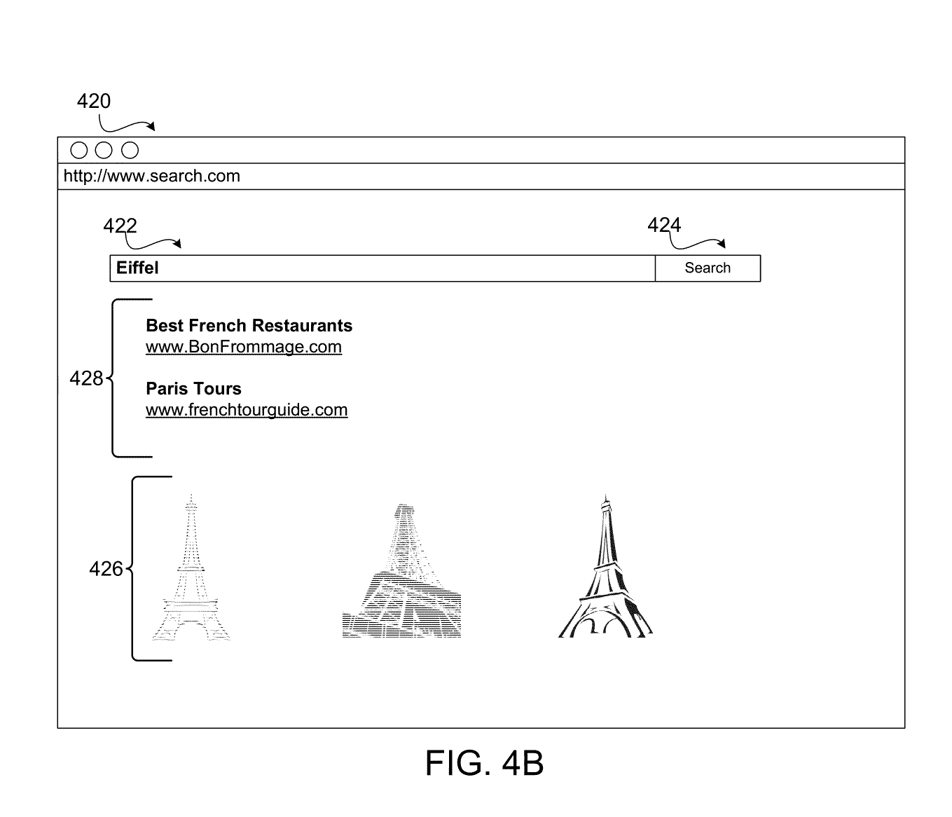

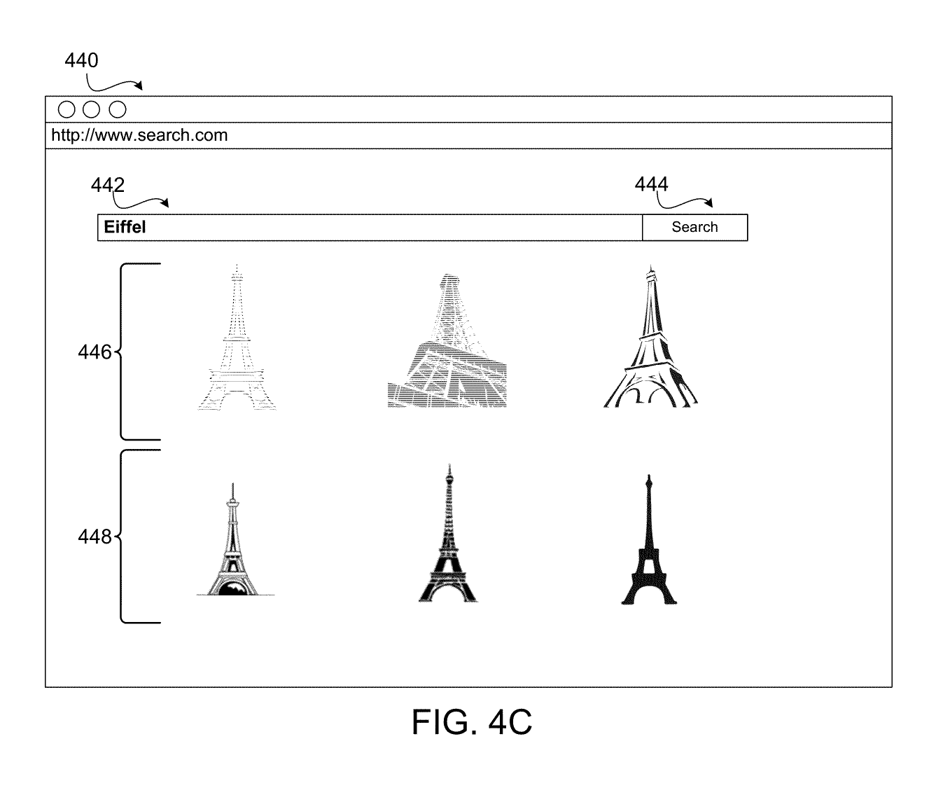

FIG. 4A is an example search result page 400 for presenting search results. The search results page 400 can include a search box 402 with a search button 404. In FIG. 4A, the search query in the search box 402 is “Eiffel”. Below the search box 402 can be a suggestion drop down menu with search queries that are related to the term “Eiffel”. The image search results 406 can be displayed below the suggestion drop down menu. The image search results 406 can be determined to be responsive to the search query in the search box 402. For example, in FIG. 4A, image search results 406 each depict the Eiffel tower, which is responsive to the search query “Eiffel”. The image search results 406 can be displayed prior to the search query being completed. For example, in FIG. 4A, the search button 404 has not been selected to signify that the user has completed entering the search query. In some implementations, the suggestion dropdown menu is still open while the image search results 406 are being scrolled. In some implementations, the image search results 406 can be updated accordingly depending on which suggestion is highlighted at the time in the suggestion dropdown menu.

FIG. 4B is an example search result page 420 for presenting search results with advertisements. The search result page 420 can include a search box 422 with a search button 424. The search result page 420 can also display advertisements 428 and image search results 426. The image search results 426 are the same as the image search results of 406 in FIG. 4A, but representing a scenario when there are content items presented. The image search results 426 can be responsive to the search query in the search box 422. For example, the image search results 426 each depict the Eiffel tower, which is responsive to the search query “Eiffel”. The advertisements 428 can also be responsive to the search query in the search box 422. For example, the advertisements 428 contain content related to French food and tours of Paris, both being responsive to the search query “Eiffel”.

In some implementations, the image search results 426 can be displayed prior to the search query being completed. For example, a suggestion drop down menu, as shown in FIG. 4A, can provide potential search queries based off of the initial input provided in the search box 422 (e.g., before the user invokes the search, for example, by selecting the search button 404 or pressing the “return” key). Once the search query is selected (e.g., the search button 424 is selected), the advertisements 428 can be displayed in the area of the user interface previously obscured by the suggestion drop down menu.

FIG. 4C is an example search result page 440 for presenting search results with additional search results. The search result page 440 can include a search box 442, a search button 444, image search results 446 and additional image search results 448. The image search results 446 correspond to the same image search results as 406 in FIG. 4A, but in the scenario in which not content items are presented with the image search results. In FIG. 4C, a search query in the search box 442 is “Eiffel”. The image search results 446 each depict the Eiffel tower, which is responsive to the search query “Eiffel”. Likewise, the additional image search results 448 each depict the Eiffel tower, also being responsive to the search query.

In FIG. 4C, the image search results 446 are above the additional image search results 448. For example, if the image search results 446 were already displayed before the search query was complete, a suggestion drop down menu would have covered the area where the image search results 446 are being displayed. Thus, the image search results can initially be presented lower in the user interface, for example, as shown in FIG. 4A. After the search query was complete, the image search results 446 are shifted into the area where the suggestion drop down menu was displayed. The additional image search results 448 are displayed in the area where the image search results 446 were formerly displayed.

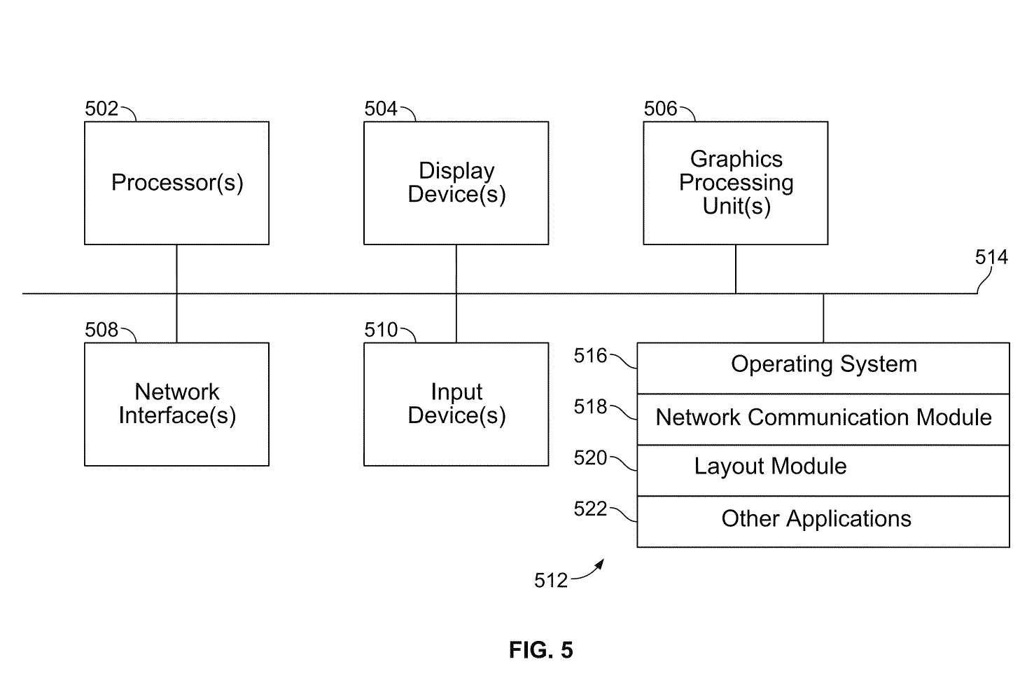

FIG. 5 illustrates an example architecture of a system 500. The system architecture 500 is capable of performing operations for presenting search results. The system architecture 500 includes one or more processors 502, one or more display devices 504 (e.g., CRT, LCD), graphics processing units 506, a network interface 508 (e.g., Ethernet, FireWire, USB, etc.), input devices 510 (e.g., keyboard, mouse, etc.), and one or more computer-readable mediums 512. These components exchange communications and data using one or more buses 514 (e.g., EISA, PCI, PCI Express, etc.).

The term “computer-readable medium” refers to any medium that participates in providing instructions to a processor 502 for execution. The computer-readable medium 512 further includes an operating system 516, a network communication module 518, image clustering module 520, and other applications 522.

The operating system 516 can be multi-user, multiprocessing, multitasking, multithreading, real-time and the like. The operating system 516 performs basic tasks, including but not limited to: recognizing input from input devices 510; sending output to display devices 504; keeping track of files and directories on computer-readable mediums 512 (e.g., memory or a storage device); controlling peripheral devices (e.g., disk drives, printers, etc.); and managing traffic on the one or more buses 514. The network communications module 518 includes various components for establishing and maintaining network connections (e.g., software for implementing communication protocols, such as TCP/IP, HTTP, Ethernet, etc.).

The layout module 520 provides various software components for performing the various functions for presenting search results including inserting available content items from multiple sources as described with respect to FIGS. 1-4C.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus.

Alternatively, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments of the invention have been described. Nevertheless, it will be understood that various modifications may be made without departing from the spirit and scope of the invention. For example, the images presented can be thumbnails of web pages from a search query for a web search. In another example, the search results can be information in tables with full cells, so that each cell needs to be displayed in its entirety or not displayed.

Accordingly, other embodiments are within the scope of the following claims.

What is claimed is:

1. A method comprising:
receiving a search query;
determining a user interface area available for presenting search results if one or more sponsored content items are included for display in the user interface area, wherein the user interface area includes a results area for presenting search results and a display area for presenting the one or more sponsored content items if the one or more sponsored content items are included;
receiving a first group of search results responsive to the search query, wherein the number of search results in the first group is selected such that the first group of search results is configured to be contained in the results area when displayed;
sending the received first group of search results for display in the results area corresponding to the user interface area available for presenting search results if the one or more sponsored content items are included;
determining whether or not the one or more sponsored content items are to be included in the display area of the user interface; and
if the one or more sponsored content items are determined not to be included in the display area of the user interface:
receiving a second group of search results comprising additional search results responsive to the query, and
sending the second group of additional search results for display in the user interface area, wherein the user interface area includes a display of the previously sent first group of search results, and wherein the results area and the unused display area of the user interface area are used to display the first group of search results and one or more search results of the second group of additional search results including moving one or more search results of the first group of search results into the unused display area.

2. The method of claim 1, where if content items are included, sending the content items for display in the display area.

3. The method of claim 1, wherein the search query is an image search query and the available user interface area is the portion of the results area for which whole image search results can be presented.

4. The method of claim 1, wherein the search query is a video search query and the available user interface area is the portion of the results area for which whole video search results can be presented.

5. The method of claim 1, wherein the content items are advertisements.

6. The method of claim 1, wherein determining the user interface area available if one or more content items are included includes:
receiving the display information including a height and width of the user interface area, and
determining a results area using the received display information, layout information, the layout information including a display area for presenting the one or more content items, and a size of the one or more content items.

7. The method of claim 1, wherein the identified search results and the additional search results are ranked, and wherein the additional search results are ranked lower than the identified search results.

8. The method of claim 1, wherein the number of the included content items is less than the number of content items that can be displayed in the display area, and wherein the additional search results are identified for display along with the content items and the identified search results.

9. A method comprising:
receiving, at a user device, a search query from a user;
sending the search query and user interface dimensions for a user interface area available to present returned search results and one or more advertisements to a search system;
receiving the search results and display area dimensions of a display area within the user interface area for the one or more advertisements;
displaying the search results in the user interface area, but not in the display area; and
receiving additional content to display, wherein receiving additional content includes:
receiving the one or more advertisements if the one or more advertisements are available and displaying the one or more advertisements in the display area; or
if the one or more advertisements are determined not to be available, shifting one or more of the displayed search results from the user interface area to the display area, receiving additional search results, and displaying the additional search results in the user interface area including shifting one or more of the previously displayed search result to in the display area and displaying the additional search results in the user interface area.

10. The method of claim 9, where if the one or more advertisements are received, displaying the one or more advertisements in the display area.

11. A non-transitory computer storage medium encoded with a computer program, the program comprising instructions that when executed by data processing apparatus cause the data processing apparatus to perform operations comprising:
receiving a search query;
determining a user interface area available for presenting search results if one or more sponsored content items are included for display in the user interface area, wherein the user interface area includes a results area for presenting search results and a display area for presenting the one or more sponsored content items if the one or more sponsored content items are included;
receiving a first group of search results responsive to the search query, wherein the number of search results in the first group is selected such that the first group of search results is configured to be contained in the results area when displayed;
sending the received first group of search results for display in the results area corresponding to the user interface area available for presenting search results if the one or more sponsored content items are included;
determining whether or not the one or more sponsored content items are to be included in the display area of the user interface; and
if the one or more sponsored content items are determined not to be included in the display area of the user interface:
receiving a second group of search results comprising additional search results responsive to the query, and
sending the second group of additional search results for display in the user interface area, wherein the user interface area includes a display of the previously sent first group of search results, and wherein the results area and the unused display area of the user interface area are used to display the first group of search results and one or more search results of the second group of additional search results including moving one or more search results of the first group of search results into the unused display area.

12. The computer storage medium of claim 11, where if content items are included, sending the content items for display in the display area.

13. The computer storage medium of claim 11, wherein the search query is an image search query and the available user interface area is the portion of the results area for which whole image search results can be presented.

14. The computer storage medium of claim 11, wherein the search query is a video search query and the available user interface area is the portion of the results area for which whole video search results can be presented.

15. The computer storage medium of claim 11, wherein the content items are advertisements.

16. The computer storage medium of claim 11, wherein determining the user interface area available if one or more content items are included includes:
receiving the display information including a height and width of the user interface area, and
determining a results area using the received display information, layout information, the layout information including a display area for presenting the one or more content items, and a size of the one or more content items.

17. The computer storage medium of claim 11, wherein the identified search results and the additional search results are ranked, and wherein the additional search results are ranked lower than the identified search results.

18. The computer storage medium of claim 11, wherein the number of the included content items is less than the number of content items that can be displayed in the display area, and wherein the additional search results are identified for display along with the content items and the identified search results.

19. A non-transitory computer storage medium encoded with a computer program, the program comprising instructions that when executed by data processing apparatus cause the data processing apparatus to perform operations comprising:
receiving, at a user device, a search query from a user;
sending the search query and user interface dimensions for a user interface area available to present returned search results and one or more advertisements to a search system;
receiving the search results and display area dimensions of a display area within the user interface area for the one or more advertisements;
displaying the search results in the user interface area, but not in the display area; and
receiving additional content to display, wherein receiving additional content includes:
receiving the one or more advertisements if the one or more advertisements are available and displaying the one or more advertisements in the display area; or
if the one or more advertisements are determined not to be available, shifting one or more of the displayed search results from the user interface area to the display area, receiving additional search results, and displaying the additional search results in the user interface area including shifting one or more of the previously displayed search result to in the display area and displaying the additional search results in the user interface area.

20. The computer storage medium of claim 19, where if the one or more advertisements are received, displaying the one or more advertisements in the display area.

21. A system comprising:
one or more processors configured to interact with a computer storage medium in order to perform operations comprising:
receiving a search query;
determining a user interface area available for presenting search results if one or more sponsored content items are included for display in the user interface area, wherein the user interface area includes a results area for presenting search results and a display area for presenting the one or more sponsored content items if the one or more sponsored content items are included;
receiving a first group of search results responsive to the search query, wherein the number of search results in the first group is selected such that the first group of search results is configured to be contained in the results area when displayed;
sending the first group of received search results for display in the results area corresponding to the user interface area available for presenting search results if the one or more sponsored content items are included;
determining whether or not the one or more sponsored content items are to be included in the display area of the user interface; and
if the one or more sponsored content items are determined not to be included in the display area of the user interface:
receiving a second group of search results comprising additional search results responsive to the query, and
sending the second group of additional search results for display in the user interface area, wherein the user interface area includes a display of the previously sent first group of search results, and wherein the results area and the unused display area of the user interface area are used to display the first group of search results and one or more search results of the second group of additional search results including moving one or more search results of the first group of search results into the unused display area.

22. The system of claim 21, where if content items are included, sending the content items for display in the display area.

23. The system of claim 21, wherein the search query is an image search query and the available user interface area is the portion of the results area for which whole image search results can be presented.

24. The system of claim 21, wherein the search query is a video search query and the available user interface area is the portion of the results area for which whole video search results can be presented.

25. The system of claim 21, wherein the content items are advertisements.

26. The system of claim 21, wherein determining the user interface area available if one or more content items are included includes:
receiving the display information including a height and width of the user interface area, and
determining a results area using the received display information, layout information, the layout information including a display area for presenting the one or more content items, and a size of the one or more content items.

27. The system of claim 21, wherein the identified search results and the additional search results are ranked, and wherein the additional search results are ranked lower than the identified search results.

28. The system of claim 21, wherein the number of the included content items is less than the number of content items that can be displayed in the display area, and wherein the additional search results are identified for display along with the content items and the identified search results.

29. A system comprising:
one or more processors configured to interact with a computer storage medium in order to perform operations comprising:
receiving a search query;
sending the search query and user interface dimensions for a user interface area available to present returned search results and one or more advertisements to a search system;
receiving the search results and display area dimensions of a display area within the user interface area for the one or more advertisements;
displaying the search results in the user interface area, but not in the display area; and
receiving additional content to display, wherein receiving additional content includes:
receiving the one or more advertisements if the one or more advertisements are available and displaying the one or more advertisements in the display area; or
if the one or more advertisements are determined not a to be available, shifting one or more of the displayed search results from the user interface area to the display area, receiving additional search results, and displaying the additional search results in the user interface area including shifting one or more of the previously displayed search result to in the display area and displaying the additional search results in the user interface area.

30. The system of claim 29, where if the one or more advertisements are received, displaying the one or more advertisements in the display area.
